(19) United States
(12) Patent Application Publication
(10) Pub. No.: US 2014/0152977 A1
(43) Pub. Date: Jun. 5, 2014

(54) SENSOR COMPONENT FOR AN OPTICAL FLOW RATE SENSOR

(71) Applicant: Schott AG, Mainz (DE)

(72) Inventors: Reinhard Ranftl, Pfeffenhausen (DE); Helmut Hartl, Wien (AT)

(73) Assignee: SCHOTT AG, Mainz (DE)

(21) Appl. No.: 14/086,490

(22) Filed: Nov. 21, 2013

Related U.S. Application Data
(63) Continuation of application No. PCT/EP2012/002175, filed on May 23, 2012.

(30) Foreign Application Priority Data
May 24, 2011 (DE) 10 2011 102 430.5

(51) Int. Cl. G01N 21/03; G01N 21/61

(52) U.S. Cl. CPC G01N 21/0303; G01N 21/61
USPC 356/51; 356/246; 29/428

(57) ABSTRACT

A sensor component for an optical flow rate sensor for fluid and/or gaseous media includes at least one component segment and at least one sensor segment. The sensor segment includes at least two inspection windows in the region of a plurality of cutouts in a sensor segment disposed such that it is possible for light to pass through a transverse section of the sensor segment. The sensor segment may include exactly one inspection window in the region of a cutout and a reflective surface, for example a mirrored or polished surface, provided on the side opposite the cutout, such that it is possible for light to pass through the sensor segment twice through a transverse section of the sensor segment. The sensor component includes a receiving component that can be inserted in the one or more cutouts and the sight glass is bonded to the receiving component.

### CROSS REFERENCE TO RELATED APPLICATIONS

This is a continuation of PCT application No. PCT/EP2012/002175, entitled “SENSOR COMPONENT FOR AN OPTICAL FLOW RATE SENSOR”, filed May 23, 2012, which is incorporated herein by reference.

### BACKGROUND OF THE INVENTION

1. Field of the Invention

The present invention relates to a sensor component for an optical flow rate sensor, for example for fluids and/or gaseous media.

2. Description of the Related Art

A sensor component in the embodiment of a flow rate sensor has become known from DE 10 2008 058 071A1 with which the physical properties of a medium, for example of a fluid or gas, are determined. The medium, whose physical properties, for example the temperature, are to be determined flows for example in a line system or is stored in container, for example in a tank. The sensor described in DE 10 2008 058 071A1 comprises only mechanical and electrical sensors such as moisture sensors, pressure sensors, capacity sensors, sensors for measuring the electrical conductivity, as well as temperature sensors. Optical sensors for a determination of the physical properties in an application according to DE 10 2008 058 071A1 where hitherto not used. A disadvantage of the capacity sensors was that only one component of the medium, in particular the fluid, preferably the fuel could be measured. Such a medium component which could be determined was, for example, ethanol.

From DE 10 2007 025 585A1 a method is known for operation of a combustion engine and a device to determine an operational parameter of same. In the method at least part of the fuel for the combustion engine is radiated with light and an intensity of the light penetrating or reflecting the fuel is determined. In DE 10 2007 025 585A1 a glass cuvette which includes two quartz glass windows is embedded in the fuel line. The glass cuvette then forms the measuring point in the fuel stream or respectively the fuel line. One disadvantage of the glass cuvette as a sensor component for an optical flow rate sensor is that the glass cuvette cannot be installed easily in the fuel line. An additional disadvantage is that the manufacture is very expensive and also an adaptation of the cross sections on the glass cuvette, in particular in the region of the quartz glass windows, is difficult.

US Patent Application Publication No. 2005/0286054A1 describes an optical sensor system for monitoring the oxygen content in a fuel inerting system in an aircraft tank. For this purpose a hollow measuring cavity is provided with glass panes of sapphire or quartz glass. The measuring cavity consists of highly porous metal foam. The measuring cavity is not provided in a fuel line but rather in the tank ullage. The sensor system known from US Patent Application Publication No. 2005/0286054A1 is therefore not suitable for use in a fuel line as a flow rate sensor.

DE 42 41 098 A1 describes a device for optical measurement of a hot exhaust flow, whereby disks which are pervious to radiation are inserted directly into an exhaust pipe. Moreover, no details are given in DE 42 41 098 A1 in regard to the material of the disks, nor to the exhaust pipe. Details as to how the disks are connected with the exhaust pipe are also missing. The device described in DE 42 41 098 A1 also has the disadvantage that an adaptation of the cross sections is very difficult.

U.S. Pat. No. 6,023,324A describes a device to determine the flow of abrasive particles in an abrasive blasting machine. No details are given in U.S. Pat. No. 6,023,324A in regard to the design of the sensor segment. It is merely suggested that the sensor segment is tubular and optically pervious.

In EP 0 967 466A1 an optical vortex flow rate sensor is described with which the flow velocity and/or the volume flow rate of a fluid can be measured. The measuring tube according to EP 0 967 466A1 has a wall into which two windows of an optical streak- and bubble free high temperature resistant glass are provided—fluid- and pressure tight, whereby the material of the measuring tube is not cited. As in all other previously described documents, the sight glass is sealed directly into the wall of the material of the measuring tube with the thereby discussed disadvantages. Another disadvantage as in all previously referred to systems is that the entire measuring tube has to be heated for the sealing process.

Measurement of physical properties of media, in particular a fluid or a gas, preferably a fuel is described in U.S. Pat. No. 7,030,629B1 as well as in US Patent Application Publication No. 2007/0056365 A1. With all of these sensors, capacitive measurements are required to sense the physical properties. As previously described, this had the disadvantage that only one component of the medium could be determined, for example ethanol.

What is needed in the art is a sensor component which avoids the disadvantages of the current state of the art. The sensor component should in particular be able to be integrated easily into a line through which the medium is transported and should allow an optical sensing of the physical properties of the medium being transported in the line. The medium to be transported may, for example, be fuel, such as gasoline, diesel fuel, rapeseed oil, methyl ester, etc. and pressure tightness is to be provided. The component should moreover be easy to produce and be adaptable to different media.

### SUMMARY OF THE INVENTION

The present invention provides a sensor component for an optical flow rate sensor for fluids and/or gaseous media including a component segment and at least one sensor segment, wherein the sensor segment has recesses which can accommodate the sight glasses. One sight glass or at least two sight glasses can be provided in the sensor segment. The sight glasses are arranged, for example, so that light penetration through a cross section of the sensor segment is possible. This may be achieved in that the two sight glasses are arranged on opposite sides.

According to the present invention it is further provided that the sensor component includes a receiving component which can be placed into the one or the plurality of recesses, whereby the receiving component accommodates the sight glass with the receiving component and the sight glass is materially joined and/or sealed to be pressure tight.

The multi-component configuration of the sensor component with the receiving component which accommodates the sight glasses, or respectively the sight glass, provides a multitude of advantages.

On the one hand it is possible to insert the sight glass into the receiving component prior to assembly with the remaining sensor component. Therefore it is not necessary to expose the entire sensor component to the high temperatures which are required for sealing. An additional advantage is that the receiving component or components can be inserted individually into the recesses. Thereby it is possible, for example, that the cross section through which the fluid medium flows in the region of the receiving components with inspection window can be adapted to the fluid medium which is to be sensed, to the optical components such as light source or to the glass materials. With the optical components an adaptation to the wavelength of the emitted light of the light source is possible, with the glass materials to their optical properties such as transparency or reflectivity.

An additional advantage of the multi-component configuration is the possibility that the material selection can be made adapted to the respective process control.

The multi-component configuration moreover offers the possibility of non-cutting production of the sensor component, predominantly through forming. The recesses can be introduced into the sensor component through punching or drilling.

In a first embodiment of the present invention, the receiving component which is to be inserted into the one or the plurality of recesses is in the embodiment of a cap, for example a high grade steel cap or Kovar or steel. As described previously, the sight glass can be inserted into the receiving component before the receiving component is inserted into the recess of the sensor segment. This has the advantage that when inserting the sight glass only the receiving component, in particular the cap and not the entire sensor segment has to be worked on or heated. First, the glass material is placed into the recess of the cap. In principle several possibilities of bonding the sight glass with the receiving component are then conceivable.

For example, the sight glass may be bonded with the receiving component by a solder material, for example a metal solder or a glass solder. When bonding the sight glass and receiving component with a metal solder or a glass solder, the coefficient of expansion of the sight glass material and the material of the receiving component are approximately equal, meaning we have a so-called adaptive sealing whereby the glass material is a glass whose coefficient of expansion is adapted to the material of the receiving component. Approximately the same coefficient of expansion in an adaptive implementation means that the coefficients of expansion deviate less than 20%, for example less than 10% from each other.

In an embodiment of the present invention with an adaptive implementation, tension tears which are caused by different coefficients of expansion at temperature changes are avoided.

If the sight glass is inserted into an essentially circular recess having an inside diameter ID of a circular receiving component having an outside diameter AD, then AD<1.2·ID, for example AD<1.1·ID, or AD<1.05·ID applies, meaning that the outside wall of the receiving component is relatively thin.

The tightness of the sensor component which includes the sight glass bonded by metal solder or glass solder into the recess is, for example, less than 10 bar, or between 1 bar and 10 bar. A receiving component which includes a sight glass which was bonded by a metal solder or a glass solder with the receiving component can be soldered into the recess of the sensor component. The sensor component in turn can be connected through soldering or laser welding with the fuel lines. When soldering the glass material the soldering temperature (first soldering temperature) is, for example, in a range between approximately 200° C. and 500° C., or in a range between approximately 250° C. to 350° C. The soldering temperature (second soldering temperature) when soldering the fuel line to the sensor component with welded in receiving component, is always lower than the soldering temperature with which the glass material is soldered into the glass cap.

In another variation of the present invention, the sight glass is sealed into the recess of the receiving component, meaning that the glass material is first placed into the recess, then the glass material and the receiving component, consisting for example of metal, are heated so that the glass material melts and that after cooling the metal shrinks onto the glass material and a frictional connection is created between the glass material and the metal of the receiving component. This represents a so-called compression seal whereby the coefficient of expansion of the glass material differs from the material of the receiving component. The difference is generally, but not necessarily greater than 20%. If the receiving component in this variation of the present invention is circular with an outside diameter AD and the recess is circular having an inside diameter ID, then the following applies in such a case: AD>1.3·ID, for example AD>1.4·ID, or AD>1.5·ID.

The advantage of this embodiment of the present invention wherein the glass material melts and forms a compression seal connection is in that the receiving component can be connected with the sensor component by brazing in the region of the recess. Brazing is done, for example, at soldering temperatures in the range of between 700° C. to 1050° C., or in a range between 800° C. to 900° C.

Subsequent to the insertion into the recess of the receiving component, this is placed into the recess in the sensor segment, and the receiving component is connected with the sensor segment, for example through soldering or laser welding for the first embodiment, or brazing or laser welding or welding for the second embodiment. Heating of the entire sensor segment for the purpose of sealing as per the current state of the art is not necessary.

The insertion of the receiving components into the recess of the sensor segment may be implemented together with soldering, laser welding or respectively brazing of sensor segment with line components, for example with the fuel line. Due to the fact that essentially all components can be worked on together, that is soldered or brazed, considerable processing time is saved compared to components in the current state of the art.

Alternatively to an integration of the sight glass into a receiving component, the sight glass can be bonded directly with the sensor segment in the region of the recess with the assistance of a metal solder.

In one embodiment of the present invention, the sight glasses are metallized at least in the edge region, that is on the circumference of their plane face in order to be able to join the sight glasses in a simple manner with the assistance of a metal solder with the metal, for example with high grade steel, Kovar or steel by soldering.

Optionally, however not absolutely required, the metallization may include a high copper content.

A sufficiently high mechanical load capacity is offered by an alkali silicate glass, a borosilicate glass, or a sapphire glass which, when provided with a metallized edge region can be bonded directly with high grade steel. Alkali silicate glass, borosilicate glass or sapphire glass may be used as sight glasses due to their high mechanical strength and high chemical resistance.

The arrangement of the sensor segment with a receiving component, for example a cap which accommodates the sight glass has the advantage that a pre-manufactured cap, for example one equipped with a sight glass, such as a metal cap, for example a high grade steel cap can subsequently be inserted in a recess of the sensor component or respectively the optical flow rate sensor in the region of the sensor segment.

Alternative to the arrangement of the receiving component in the embodiment of a cap, a ring form would also be conceivable, whereby the ring accommodates one or a plurality of sapphire glasses and the ring, together with the sapphire glasses, is arranged in the region of the recess of the sensor segment. For this purpose the ring can be soldered together with the sensor segment.

The sensor component may be formed as a tube-shaped body having a cross section, for example a circular cross section.

In an arrangement of this type it is advantageous if cross section Q₁ of the sensor component in the sensor segment is substantially the same as cross section Q₂ of the connected line components. This has the advantage that only a small flow resistance occurs at the transition from the line components to the sensor segment.

By adjusting distance A of the receiving components from each other in the recesses, the optical properties of the light source or of the glass materials or of the medium which is to be sensed can be easily adjusted. Through the additional adjustment of the inside diameter of the sensor component DS it is possible to adapt cross section Q₁ to cross section Q₂ of the feed line.

An additional advantage of the inventive arrangement is that the size of the recess in the receiving component can be adjusted. The size of the recess and thereby the diameter for the sight glass is selected so that the optical requirements can be met, for example in relation to the beam width of the irradiated volume.

In addition to the sensor component, the present invention also provides an optical flow rate sensor with at least one optical sensor, whereby the optical flow rate sensor includes a sensor component according to the present invention.

The optical flow rate sensor may include a light source, for example a light emitting diode, such as a light emitting diode array.

The light source, in particular the light emitting diode, or the light emitting diode array emits light, for example in a wavelength in the infrared, such as in the wavelength range of between approximately 1 micrometer (μm) and 2 μm.

Other wavelengths are also conceivable. For example such wavelengths which have a sufficiently high transmission at the penetration through the fluid and/or gaseous medium to be measured are conceivable. In this context we refer you to DE 10 2007 025 585A1, the disclosure content of which is incorporated herein in its entirety. One type of optical sensor includes a light source, for example an LED-light source array which directs the light after a beam splitter through the first sight glass, the medium, for example the fluid, or the fuel with the fluid to be detected and through the second sight glass to a first detector, which detects the incoming light signal. It is further feasible for the arriving light beam to be detected spectrally resolved. In such a case, several substances which flow through the optical flow rate sensor can be detected with the detector. If only one substance is to be detected with the detector, then the detection, for example of a single wavelength which is characteristic for the substance would be sufficient. After the beam splitter a part of the light of the light source is directed directly to a second detector where it is also detected spectrally resolved. From a comparison of the signal of the first detector with the signal of the second detector, conclusions can be drawn in regard to the composition of the medium, for example the fluid, or the fuel.

It is further feasible for the sight glass to be a plane-parallel, mechanically durable glass disk which can be joined with a metal, for example high grade steel, Kovar or steel. The plane-parallel glass disk which can be joined with metal, for example high grade steel, Kovar or steel is mechanically durable. The glass disk may be flat as well as bent, in order to represent optical properties. The term “glass disk” in the current invention is understood to be different embodiments—a single glass disk, as well as laminate or composite disks of glass. The glass disk is formed for special functions, for example filter functions, for example as edge filters, color filters or transmission filters. The glass disks may moreover also be provided with coatings, such as functional coatings, for example anti-reflex coatings or coatings blocking specific wavelengths, such as UV-coatings or IR coatings.

In addition to the inventive optical flow rate sensor, the present invention also provides a device to receive and/or transport fluid or gaseous media with such an optical flow rate sensor.

Media whose physical properties can be measured in the line or in the container with the help of an optical flow rate sensor are gases or fluids. A gas to be considered is, for example, natural gas in gaseous as well as in compressed or liquid form or automobile gas. Industrial gases such as for example hydrogen, N₂, O₂, and also in liquid form such as liquid hydrogen and liquid nitrogen can be measured. Moreover exhausts from combustion engines as well as process gases of the chemical and semiconductor industry and air can be evaluated in regard to their physical properties. Additional media which can be measured in the lines or respectively containers in regard to their physical properties with the assistance of the inventive sensor component are water, salt water, oils, for example for transmissions, hydraulic oils, alcohols, such as methanol, ethanol, propanol, butanol, butane oil in particular as an additive to fuels. Additional fluids whose physical properties can be measured with the inventive arrangement in a sensor device are fuels such as gasoline and diesel fuel, rapeseed oil, methyl ester, as well as fuels for aircraft turbines or ship engines and/or turbines. Also fluid substances for emission control such as urea or urea solution which are currently used in emission control on diesel vehicles can be detected in a line or a container with the assistance of the inventive implementation. Moreover, any type of process fluid in the industry, in particular in the chemical industry and the semi-conductor industry can be sensed in a line or respectively in a tank with assistance of the inventive implementation. Mediums which are used in air conditioning systems or refrigerators, such as for example fluorinated hydrocarbons can be detected with the assistance of the inventive device.

The herein cited enumerations of gases or respectively fluids which are detectable with the assistance of the inventive device are only exemplary and are not in any way to be understood to be restricted to same.

The device includes, for example, line components which are connected with the sensor component such as the component segments, for example materially joined, such as through soldering, brazing or welding, for example laser welding.

The inventive flow rate sensor is, for example, used in fuel lines, in particular to determine the composition of fuel mixtures. In addition to the optical flow rate sensor, sensor component for short, of the device for receiving and/or transporting fluid or gaseous medium with an optical flow rate sensor of this type, the present invention also provides a method for producing a sensor component for an optical flow rate sensor. The inventive sensor component for an optical flow rate sensor can be produced in different ways. With the inventive method the sight glass is first placed into a receiving component, for example a cap and joined with same. Subsequently, the receiving component with the sight glass is introduced into the recess of the sensor component. To insert the sight glass into the receiving opening of the receiving component, sight glass and receiving component can be heated according to a first method, so that the sight glass is compression sealed into the at least one receiving opening. The glass hereby melts. Subsequently, the receiving component is inserted into the recess and is connected with the sensor component or segment in the region of the recess.

Alternatively to direct sealing into the receiving opening of the receiving component, a solder glass can be placed into the at least one receiving opening. Subsequently the sight glass is inserted and sight glass and receiving component are heated in such a way, that the solder glass fuses with the sight glass in the receiving aperture in the form of a compression seal. Afterwards the receiving component is placed into the recess and joined with the sensor component or segment in the region of the recess.

The advantage of the previously described two methods in which the glass material is melted and placed into the receiving aperture in the form of a compression seal is the possibility of joining the receiving component with the sensor component through brazing or laser welding. The sensor component can also be connected with, for example, line components by brazing. Glass materials suitable for direct sealing are alkali silicate glasses, for example glass B270 of SCHOTT AG with a coefficient of expansion of α≈10·10⁻⁶ K or borosilicate glasses, for example glass 8800 or 8436 of SCHOTT AG with a coefficient of expansion of α≈5 to 6·10⁻⁶ K.

One possible exemplary glass combination for sealing a sight glass using of a glass solder is the combination of the borosilicate glass 8800 of SCHOTT AG as sight glass with glass G018161 as the glass solder. Alternatively, the borosilicate glass 8800 of SCHOTT AG can also be used as glass solder in combination with sapphire glass as the sight glass.

In an additional alternative method the sight glass is first metallized, at least in the edge region. Then the metallized sight glass is soldered into the receiving component, for example the cap, in particular a high grade steel cap. Alternatively to a cap, a ring could also be introduce in the region of the recess, whereby one or a plurality of sight glasses are arranged in the ring. After producing the cap or the ring and equipping same with the sight glass or glasses, the cap or the ring with the sight glass welded into it are connected with the sensor component, for example in the region of the opening of the sensor component, for example through welding, such as laser welding or soldering.

In an additional embodiment, the sensor segments of the sensor component can be provided in the region of the recess with a glass solder, such as a glass ring or a glass solder ring to produce the sensor component for the flow rate sensor for fluids and/or gaseous mediums. Subsequently, the sight glass is joined with the glass solder ring, for example through fusing. Since the glass solder has generally a low fusing temperature, the thermal load on the sensor component and the sight glass is generally low.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a principle view of a sensor component according to the present invention with a sight glass bonded with the receiving component using metal solder or glass solder;

FIG. 2 is a sight glass with illuminants and sensors;

FIG. 3 is a receiving component with a sight glass whose edge region is metallized;

FIG. 4 is a cross section through the sensor component in the region of the cap according to FIG. 3;

FIG. 5 is an alternative arrangement of a connection of sight glass and high grade steel tube;

FIG. 6 is a receiving component with a sight glass sealed directly into it;

FIG. 7 is a receiving component with a sight glass sealed using a glass solder;

FIG. 8 is a principle view of a sensor component with a sight glass sealed directly into it, according to FIG. 6 or 7; and

FIG. 9 is a cross section through the sensor component in the region of the cap according to FIG. 6 or 7.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

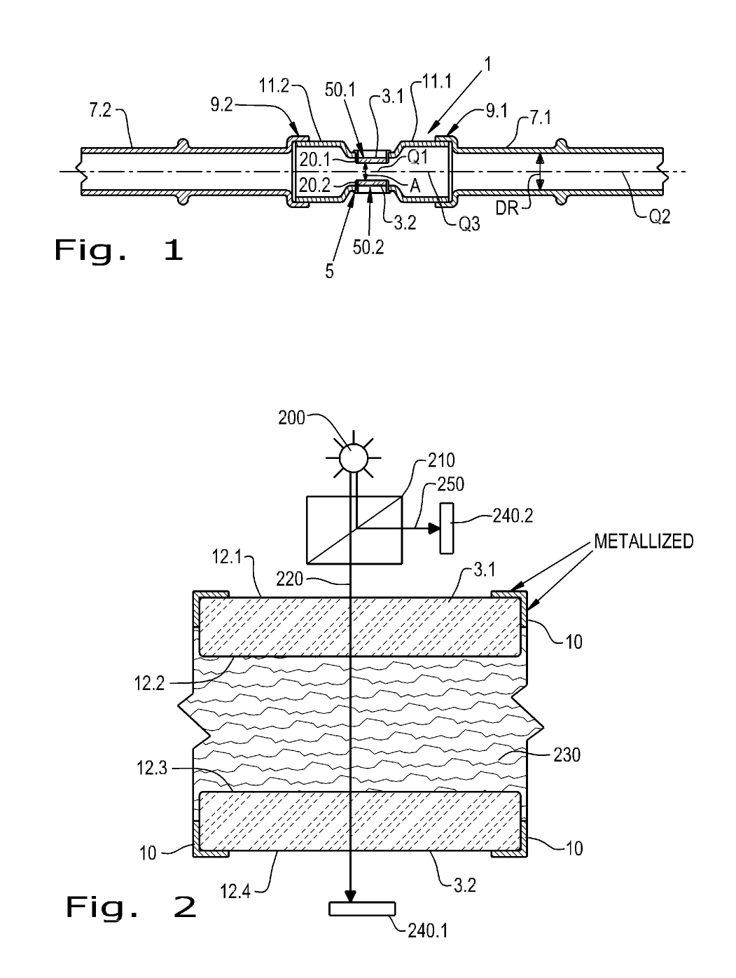

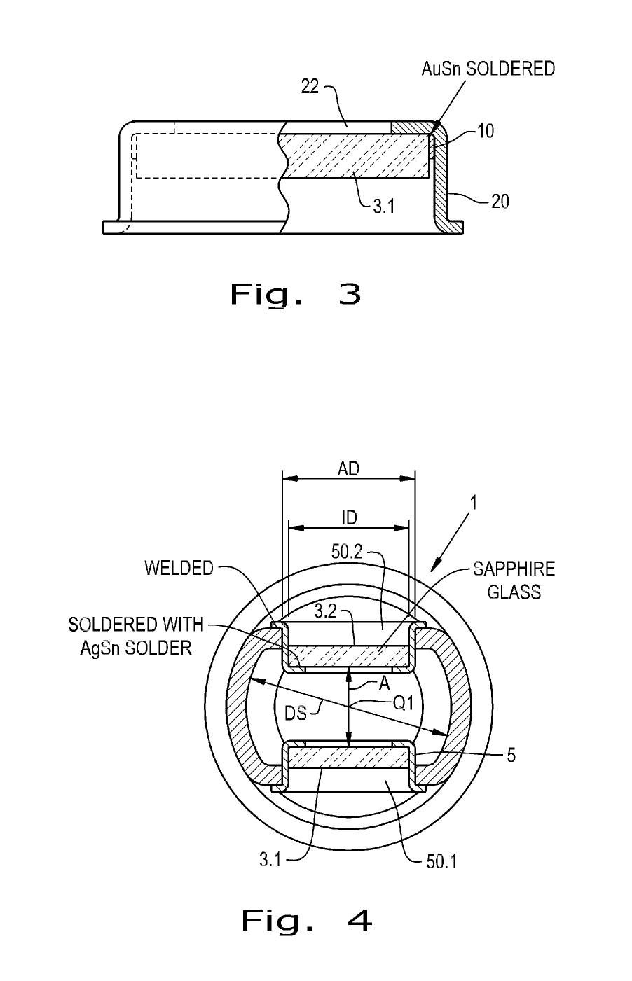

Referring now to the drawings, and more particularly to FIG. 1, there is shown a principle view of a sensor component 1 according to the present invention with two sight glasses 3.2, 3.1, installed in the region of a sensor segment 5 of the sensor component for an optical flow rate sensor 4. In the current view, sight glasses 3.2 and 3.1 are shown bonded with a metal solder or glass solder with a receiving component, here in the embodiment of a cap 20, 20.1, 20.2 as detailed in FIG. 3, and respectively inserted into a recess 50.1, 50.2 of the sensor component and materially joined with sensor component 1, for example through soldering or laser welding. Sensor component 1, and thereby the optical flow rate sensor, is installed in or connected to a line with line components 7.1, 7.2. The connection of line components 7.1, 72 with the sensor component of optical flow rate sensor 1 occurs in region 9.1, 9.2 of sensor component 1. Sensor component 1 of the optical flow rate sensor includes, in addition to sensor segment 5, two component segments 11.1, 11.2 which are connected with line components 7.1, 7.2. The optical flow rate sensor includes a light source, a beam splitter as well as two optical detectors, a first detector and a second detector. This is illustrated in detail in FIG. 2. Sensor component 1 for the optical flow rate sensor is, for example, a tube shaped body having a cross section, such as a circular cross section. The tube shaped body may, for example, be a high grade steel pipe.

In the embodiment shown in FIG. 1, the cross section of sensor segment 5 or respectively of the tube shaped body narrows from Q₂ to Q₁ in the region of sensor segment 5 with sight glasses 3.1, 3.2. This is advantageous, however not absolutely necessary. Sight glasses 3.1, 3.2 in the embodiment according to FIG. 1 are arranged on opposite sides of the sensor segment. The arrangement of sight glasses 3.1, 3.2 determine cross section Q₁ in the region of the sensor segment. Cross section Q₁ in the region of the sensor segment is determined on the one hand by distance A of the two receiving components with the sight glasses, as well as the inside diameter DS of the sensor component. By adjusting distance A of the receiving components relative to each other in the recesses of the sensor component the optical properties of the sensor component can be easily adjusted. It is possible in particular to select the distance, depending on the transparency of the medium to be sensed, in particular so that in consideration of the light source and the optical properties of the glass material an irradiation sufficient for a measurement of the medium is ensured. The inside diameter DS of the sensor component is then selected so that cross section Q₁ in the sensor segment is substantially consistent with cross section Q₂ in the region of the line components. Since the line components are generally tubes having a circular cross section and an inside diameter DR, Q₂ is Q₂=Π·(DR/2)². Since the receiving components, for example the caps with the sight glasses in the recesses of the sensor segments can be moved vertically, that is perpendicular to the direction of axis, the distance of the caps relative to each other and thereby the cross section Q₁ in the region of the sensor section can be adjusted, adapted for example to the flow medium, the light source or the optical properties of the sight glasses. An additional advantage is that the size of the recess in the receiving component and the diameter of the sight glass can be adapted to the optical requirements.

In the embodiment of the present invention illustrated in FIG. 1 the sight glass or sight glasses 3.1, 3.2 are sealed into the receiving component in the form of a high grade steel cap according to a first embodiment of the present invention with a metal solder. The receiving component in the current example is circular and has an outside diameter AD and a circular receiving opening 22 having an inside diameter ID, as shown in FIG. 1. On the receiving component according to FIG. 1, the outside wall is very thin, that is AD<1.2·ID, for example AD<1.1·ID, or AD<1.05·ID. In order to be able to join the sight glass with the receiving component with the very thin outside wall, for example through soldering with a metal solder, sight glasses 3.1, 3.2 are metallized. Sight glasses or inspection windows 3.1, 3.2 are for example metallized sapphire glasses which are plane parallel and are placed into a receiving component, in this case a high grade steel cap 20. Other glass materials are also conceivable. In the current example sight glass 3.1, 3.2 is provided with metallization 10 in the edge region on one side of the plane parallel surfaces 12.1, 12.2, 12.3, 12.4. Metallization 10 may be applied to be able to join sight glass 3.1, 3.2 with the metal, in particular with the high grade steel of receiving component 1 in a simple manner, for example by soldering. This is shown in detail in FIG. 2.

Also shown in detail in FIG. 2 is one possibility for an optical sensor, as it can be configured in an optical flow rate sensor. Also illustrated, however without restriction thereto, are sight glasses 3.1, 3.2 as to how they can be inserted in a receiving component, in particular a high grade steel cap, as shown for example in FIG. 1 by soldering with a metal solder.

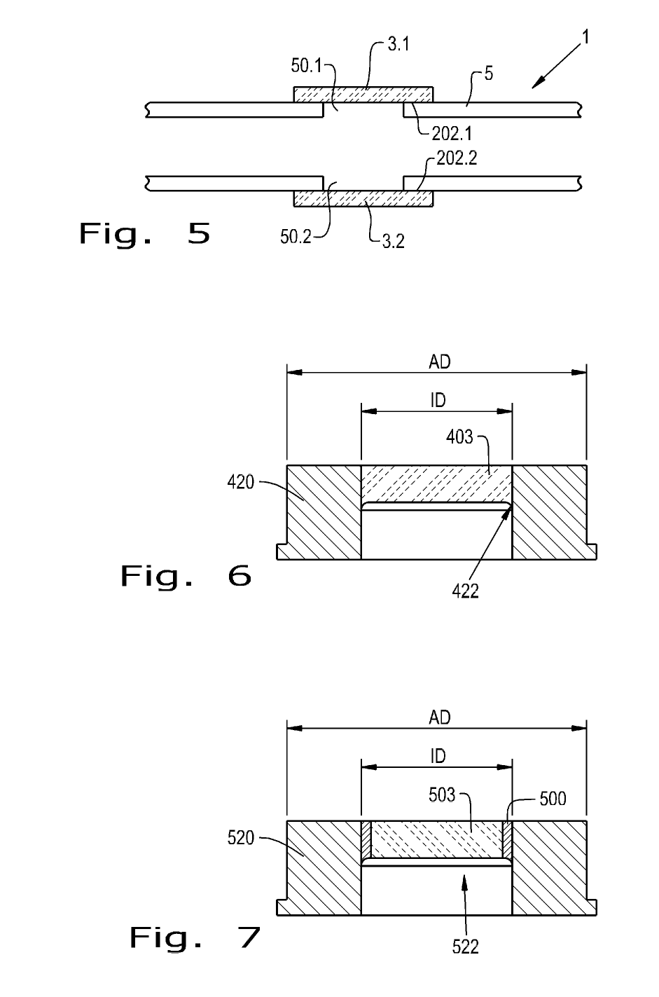

Also in an embodiment with an inspection window sealed into the receiving component according to FIGS. 6 to 7 and an inspection window directly placed on the sensor component according to FIG. 5, the optical sensor illustrated in FIG. 2 may also be utilized without restriction thereto.

The optical sensor includes a light source 200 which can be a light emitting diode which emits light in the infrared (IR)-wavelength range of, for example, 1 μm to 2 μm. In the light path after the light source a beam splitter 210 is guided through first sight glass 3.1, into the interior of the sensor component (not shown). Part 220 of the light penetrates medium 230 in the interior of the sensor component, is weakened for example through absorption which is specific to the medium which is being irradiated, penetrates through second inspection window 3.2 and then impinges a first detector 240.1. The impinging light is spectrally split on first detector 240.1. The weakening of the light signal at a specific IR-wavelength then permits conclusions in regard to the composition of the irradiated medium, for example analog to the IR-spectroscopy. In order to be able to quantify the absorption through the medium, another part 250 of the light of light source 200 is guided to a second detector 240.2 after beam splitter 210, where it is also again spectrally split. A comparison of the signal of the first detector and the second detector then permits a direct quantification.

Alternatively to the previously described embodiment with the two detectors it would also be conceivable to use a single detector and to operate the light source in an alternating pulsed operation. As described, sight glasses 3.1, 3.2 which are provided with metallization 10 can be soldered into a receiving opening 22, or above a receiving opening with the receiving component, in particular in the embodiment of cap 20 with a metal solder. When soldering with a glass solder, metallization can be omitted. Soldering is hereby preferably used. The soldering temperature is, for example, in the range of between approximately 200° C. to 500° C. or in the range of between approximately 250° C. to 350° C. Soldering is especially easy, if the metallization includes a high copper content.

As shown for example in FIG. 1, with the sensor component, the sight glass, for example the borosilicate glass or sapphire glass may be inserted directly or indirectly into a recess or opening or is placed on the recess or opening of sensor component 1 in the region of sensor segment 5, or is directly welded on.

Referring now to FIG. 3, there is shown an example for a receiving component in the embodiment of a high grade steel cap 20 with a thin outside wall, which was produced for example through deep drawing. The high grade steel cap has an opening or receiving opening 22. Above opening or receiving opening 22 the sight glass, for example sapphire glass 3.1, is inserted and welded together in the region of metallization 10 with high grade steel cap 20. Au/Sn is used in this case, for example, as the solder material.

After producing the receiving component, in particular the high grade steel cap with a sight glass, for example a sapphire glass, it is inserted—as shown in FIG. 4—into recess 50.1, 50.2 in sensor segment 5 of sensor component 1 of FIG. 1. Joining of high grade steel cap 20 which accommodates sight glass 3.1, 3.2 with sensor segment 5 of sensor component 1 can occur by welding or soldering. Moreover it can be seen in FIG. 4 that sight glasses 3.1, 3.2 are located opposite each other at a distance A, so that light can penetrate from one side of sensor component 1 to the other side, thus enabling determination of the physical properties of the fluid passing between sight glasses 3.1, 3.2. Clearly seen in FIG. 4 are recesses 50.1, 50.2 of sensor component 1 for the optical flow rate sensor into which the receiving components, in particular caps 20 which include sight glass 3.1, 3.2 at a distance A, are inserted in the current example.

Cross section Q₁ in the region of the sensor segment is determined on the one hand by distance A of the two receiving components with the sight glasses, as well as the inside diameter DS of the sensor component. By adjusting distance A of the receiving components relative to each other in the recesses of the sensor component, the optical properties of the sensor component can be easily adjusted. It is possible in particular to select the distance, depending on the transparency of the medium to be sensed, in particular so that in consideration of the light source and the optical properties of the glass material an irradiation sufficient for a measurement of the medium is ensured. The inside diameter DS of the sensor component is then selected so that cross section Q₁ in the sensor segment is substantially consistent with cross section Q₂ in the region of the line components. Since the line components are generally tubes having a circular cross section and an inside diameter DR, Q₂ is Q₂=Π·(DR/2)².

An additional advantage is that the size of the recess in the receiving component and the diameter of the sight glass can be adapted to the optical requirements.

Instead of the accommodation of sight glass 3.1, 3.2 in a receiving component and insertion of the receiving component into recess 50.1, 50.2 of the sensor component, sight glass 3.1, 3.2 can also be placed directly into the recess and joined, for example through soldering of metallized glass components into the recess. A variation of this type however has the disadvantage that the distance of the sight glasses is determined by the geometry of the sensor component. Because of this an easy adjustment of the distance of sight glasses 3.1, 3.2 relative to each other is not possible, and thereby the optical properties cannot be adjusted.

Alternatively to welding sight glass 3.1, 3.2 into the recess, sight glass 3.1, 3.2 can be welded onto sensor segment 1 in the region of recess 50.1, 50.2. FIG. 5 illustrates such an alternative arrangement of joining of sight glasses with the sensor component which is for example in the embodiment of a high grade steel tube. Instead of inserting the sight glass, for example the sapphire glass, into a receiving component, for example a high grade steel cap or a recess, as shown in FIGS. 3 and 4, it may be provided to place sight glass 3.1, 3.2 onto sensor component 1, for example in a tubular shape, in the region of recesses 50.1, 50.2 of sensor segment 5. Sight glasses 3.1, 3.2, such as sapphire glasses, are soldered with metal solder to the sensor segment in region 202.1, 202.2.

Referring now to FIGS. 6 and 7, there is shown the second alternative possibility of placing and joining at least one sight glass into the receiving opening of a receiving component which is then brought into the recess of the sensor component and is joined with same. As previously described, the sight glass is joined with the receiving component in a first step. The receiving component is hereby pre-manufactured. The pre-manufactured receiving component is then joined in an additional process step with the sensor component in the region of the recess, for example through welding, for example laser welding, soldering or brazing. Distance A between the sight glasses can hereby be adjusted.

In the embodiment according to FIGS. 6 to 9, the outside wall of the receiving component is sufficiently strong, so that the glass can be sealed into the receiving component in the form of a compression seal. If the receiving component is circular with an outside diameter AD and the receiving opening which is worked into the receiving component for example through drilling or punching has an inside diameter ID, then a sufficient wall thickness is provided for AD>1.3·ID, for example AD>1.4·ID, or AD>1.5·ID. Outside diameter and inside diameter are shown in FIGS. 6, 7 and 9.

FIG. 6 shows an arrangement of the present invention wherein sight glass 403 is sealed directly into the receiving opening of the receiving component which, in the current example is in the embodiment of circular ring 420, which may be made of high grade steel, Kovar or steel without being limited thereto. Direct sealing occurs through inserting of sight glass 403 into receiving opening 422 of the receiving component which is made, for example of a steel, such as high grade steel or Kovar and through subsequent heating, causing the glass material to melt and the metal, namely the high grade steel, to shrink onto the glass material of the sight glass, resulting in a compression seal. The compression seal is the result of the different thermal expansions of the glass material and the metal of the receiving component. For compression sealing glasses having a very high fusing temperature of greater than 800° C., for example greater than 900° C., or greater than 950° C. may be used, for example borosilicate glasses, aluminum silicate glasses or a sapphire glass. Glasses having a high fusing temperature have the advantage that the receiving component and thereby the entire sensor component can be brazed. Connection to the line components through brazing is also conceivable.

An additional advantage of compression sealing is that a pressure seal is ensured also at high pressures, for example pressures of at least 10 bar. Exemplary materials for the sight glass are borosilicate glass, alkali silicate glass, for example glass B270 by SCHOTT AG, Mainz or a sapphire glass.

Referring now to FIG. 7, there is shown one embodiment of the present invention, wherein sight glass 503 is sealed into the receiving opening of the receiving component by glass solder 500, whereby in the current example the receiving component is in the embodiment of circular ring 520, made for example of high grade steel without being limited thereto. Sealing occurs through placing glass solder 500 together with sight glass 503 into receiving opening 522 of the receiving component which consists, for example of a steel, such as high grade steel, and subsequent heating, causing the glass solder to fuse pressure tight with the metal and sight glass 503. As in the embodiment according to FIG. 6, the embodiment according to FIG. 5 shows also a compression seal, meaning a non-adapted seal whereby the coefficient of expansion of the different materials, that is those of the glass materials and the metals, differ from each other. In the non-adapted implementation the coefficient of expansion of the glass materials and metals can differ by more than 20%.

In contrast to direct sealing according to FIG. 6, a pressure tight metal-sight glass bond can be achieved when using glass solder at low temperatures, since the glass solder has lower fusing temperatures than the sight glass. Possible combinations are use of glass solder G018161 in combination with sight glass 8800, a borosilicate glass or the use of the borosilicate glass 8800 with a sapphire glass as the sight glass. In particular for the sapphire glass having a melting temperature above 1000° C. for which direct sealing is not possible, sealing with the assistance of high melting glass solder presents a possibility of placement into a recess of the receiving component in the form of a compression seal.

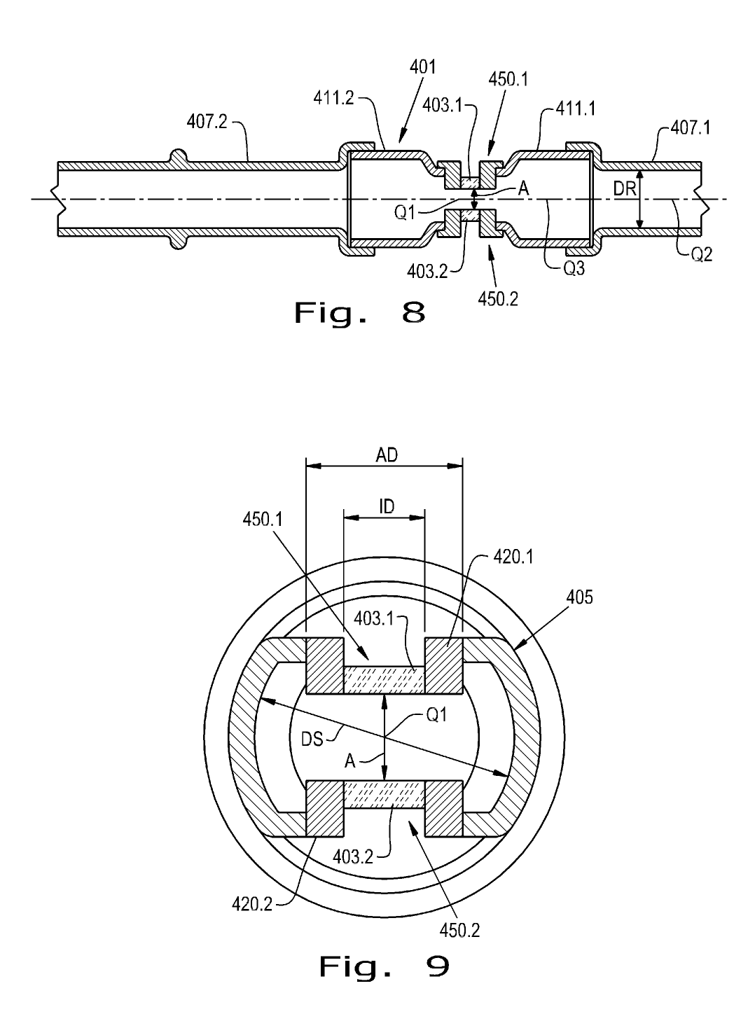

Referring now to FIG. 8, there is shown a cross section through a sensor component, as illustrated in FIG. 4. Same components as shown in FIG. 4 are identified by reference numbers increased by 400. In contrast to FIG. 4, the receiving component which is inserted in FIG. 8 into recesses 450.1, 450.2 of the sensor component is a receiving component with a compression seal according to FIG. 6 or FIG. 7, to which reference is made here. With the exception of providing the recesses, the sensor component can be produced in a simple manner through shaping. Line components 407.1, 407.2 can also be produced through shaping. Line components 407.1, 407.2 have a cross section Q₂. Cross section Q₂ of line components 407.1, 407.2 is approximately consistent with cross section Q₁ of the sensor component in the region of the sight glasses. This is illustrated in FIG. 9. Because the cross section in the region of the line is largely consistent with the cross section in the measuring region, no losses occur due to flow resistances. The cross section of the sensor component in the region of component segments 411.1, 411.2 is larger than Q₁ and Q₂ and is selected so that line components 407.1, 407.2 can be connected to the sensor component, for example line components 407.1, 407.2 are brazed or laser welded with component segments 411.1, 411.2. Cross section Q₁ in the region of the sensor component is determined through distance A of the sight glasses relative to each other and the inside diameter DS. Distance A is adjustable. By adjusting distance A of the receiving components relative to each other in the recesses of the sensor component the optical properties of the sensor component can be easily adjusted. It is possible in particular to select the distance, depending on the transparency of the medium to be sensed, in particular so that in consideration of the light source and the optical properties of the glass material an irradiation sufficient for a measurement of the medium is ensured. The inside diameter DS of the sensor component is then selected so that cross section Q₁ in the sensor segment is substantially consistent with cross section Q₂ in the region of the line components. Since the line components are generally tubes having a circular cross section and an inside diameter DR, Q₂ is Q₂=Π·(DR/2)².

An additional advantage is that the size of the recess in the receiving component and the diameter of the sight glass can be adapted to the optical requirements.

Shown in FIG. 9 as is the case in FIG. 4 is a cross section through the sensor component in the region of the sensor segment. In contrast to FIG. 4, the receiving component has a sufficiently strong outside wall, as shown in FIG. 6, in order to be able to accommodate the glass material or respectively sight glasses 403.1, 403.2 in the embodiment of a compression glass in the receiving opening. The receiving component in FIG. 9 is in the embodiment of circular ring 420.1, 420.2 having an outside diameter AD>1.3·ID, for example AD>1.4·ID, or AD>1.5·ID. The receiving component is brazed into recesses 450.1, 450.2 in sensor segment 404 which, in the current example is tubular. Also shown in FIG. 9 is distance A of the two receiving components which are in the embodiment of circumferential ring 420.1, 420.2, as well as the inside diameter ID which, together determine cross section Q₁ in sensor segment 405.

Alternatively to the illustrated embodiment with two recesses 50.1, 50.2, 450.1, 450.2 and a detector arranged in the direction of radiation of the laser beam it would also be conceivable to provide only one recess with one sight glass and on the side opposite the recess a reflecting or mirrored or polished surface so that the light beam which is directed through the medium reflects and is directed to the detector arranged on the same side as the light source. An arrangement of this type has the advantage that the optical path is doubled by passing through the medium twice which is advantageous in particular with small transmission changes, for example with highly diluted substances or when measuring detection wavelengths which are at or near the absorption minimum of the substance to be detected. An arrangement of this type is comprehensible to the expert, even though it is not explicitly illustrated.

With the present invention a sensor component is specified for the first time which permits an optical measurement of fluid mediums, in particular fuel, fuel components, natural gas, hydrogen, nitrogen, oxygen, exhausts from combustion engines, industrial process gasses, liquid petroleum gas, air, water, in particular salt water, oils, in particular for engines, transmission and hydraulic applications, alcohols, in particular methanol and ethanol, gasoline, diesel fuel, rapeseed oil, methyl ester, fuel for aircraft turbines, urea and urea solutions, fluoric-hydrocarbons.

The distance of the receiving components can moreover be adjusted very easily to different mediums, light sources, etc. without changing the sensor component in whose recess or recesses the receiving component or components are inserted. The inside diameter DS in the sensor segment can in turn be adapted to the distance in the region of the sensor segment, so that the flow rate cross section Q₁ in the region of the sensor segment is consistent with the line cross section Q₂ of the connected lines, thereby being able to reduce flow resistances. The arrangement according to the present invention with one sight glass inserted into one receiving opening of the receiving component in particular allows for the size and the diameter of the sight glass to be adapted easily to the optical requirements. An additional advantage is the ease of production through shaping and for the pressure seals, that the individual components can be brazed.

The present invention relates to aspects which are a set forth in the following clauses, which are part of the description, but are not claims.
1. An optical flow rate sensor, for example for fluids and/or gaseous media (1) includes at least one component segment (11.1, 11.2) and at least one sensor segment (5) to accommodate an optical sensor, and the sensor segment (5) includes at least one sight glass (3.1, 3.2).
2. The optical flow rate sensor (1) according to clause 1 is further defined in that sensor segment (5) includes at least two sight glasses (3.1, 3.2), for example in the region of one or a plurality of recesses (50.1, 50.2), which are arranged in such a way that light penetration through a cross section (Q₂) of sensor segment (5) becomes possible, or that sensor segment (5) includes specifically one sight glass (3.1), for example in the region of one recess and that on the side opposite the recess a reflecting surface, such as a mirrored or polished surface is provided so that it becomes possible for the light to penetrate twice through a cross section (Q₂) of the sensor segment.
3. The optical flow rate sensor according to one of the clauses 1 to 2 is further defined in that sight glass (3.1, 3.2) is a plane-parallel, mechanically durable glass disk which can be joined with a high grade steel.
4. The optical flow rate sensor according to one of the clauses 1 to 3 is further defined by sight glass (3.1, 3.2) having a plane face (12.1, 12.4) with an edge region (10) wherein the edge region (10) is metallized.
5. The optical flow rate sensor according to clause 4 is further defined for the metallization to include a copper component.
6. The optical flow rate sensor according to one of the clauses 1 to 6, is further defined by the sight glass (3.1, 3.2) being a borosilicate glass for example a sapphire glass.
7. A sensor component according to one of the clauses 1 to 6 is further defined by the sensor segment (5), for example in the region of recess(es) (50.1, 50.2) including a cap (20), such as a high grade steel cap or a cap (20) of Kovar or steel which accommodates sight glass (3.1, 3.2).
8. The optical flow rate sensor according to one of the clauses 1 to 6 is further defined by the sensor segment (5), in the region of recesses (50.1, 50.2) including a glass ring (200.1, 200.2) which is fusible with sight glass (3.1, 3.2) and/or the material of sensor segment (5).
9. A device to receive or transport a fluid or gaseous medium, includes at least one optical flow rate sensor (1) according to one of the clauses 1 to 8.
10. The device according to clause 9 is further defined to be configured or formed for use with a fluid or gaseous medium, which is one of the following mediums:
natural gas, hydrogen, nitrogen, oxygen, exhausts from combustion engines, industrial process gasses, liquid petroleum gas, air, water, in particular salt water, oils, in particular for engines, transmission and hydraulic applications, alcohols, in particular methanol and ethanol, gasoline, diesel fuel, rapeseed oil, methyl ester, fuel for aircraft turbines, urea and urea solutions, and/or fluoric-hydrocarbons.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sensor component for an optical flow rate sensor for at least one of a plurality of fluids and a gaseous media, the sensor component comprising:
at least one component segment; and
at least one sensor segment comprising a receiving component and at least one sight glass, said at least one sensor segment including one of:
at least two sight glasses in a region of a plurality of recesses in said at least one sensor segment, said receiving component being insertable into said plurality of recesses and said at least two sight glasses being arranged such that a cross section of said at least one sensor segment is penetrable with a light, said at least two sight glasses being materially joined with said receiving component; and
one sight glass in a region of one recess of said at least one sensor segment and a reflecting surface on a side opposite said one recess, said receiving component being insertable into said one recess and said one sight glass being materially joined with said receiving component.

2. The sensor component according to claim 1, wherein said reflecting surface is one of a mirrored surface and a polished surface arranged such that a cross section of said at least one sensor segment is penetrable twice by a light.

3. The sensor component according to claim 1, said at least one sight glass being sealed directly into a receiving opening of said receiving component.

4. The sensor component according to claim 3, said at least one sight glass being sealed into said receiving opening with a compression seal.

5. The sensor component according to claim 1, said at least one sight glass being sealed into a receiving opening of said receiving component with a glass solder.

6. The sensor component according to claim 5, said at least one sight glass being sealed into said receiving opening with a compression seal.

7. The sensor component according to claim 1, said at least one sight glass being soldered into said receiving component with one of a metal solder and a glass solder.

8. The sensor component according to claim 7, said at least one sight glass being a plane-parallel, mechanically durable glass disk which is joinable with a metal.

9. The sensor component according to claim 8, wherein said metal is steel.

10. The sensor component according to claim 9, wherein said steel is one of high grade steel and Kovar.

11. The sensor component according to claim 5, said at least one sight glass having a plane face with an edge region, said edge region being metallized.

12. The sensor component according to claim 11, wherein said metallized edge region is soldered.

13. The sensor component according to claim 12, said solder including a copper component.

14. The sensor component according to claim 1, said at least one sight glass being a borosilicate glass.

15. The sensor component according to claim 14, said at least one sight glass being a sapphire glass.

16. The sensor component according to claim 1, said at least one sight glass withstands pressures of at least 10 bar.

17. The sensor component according to claim 1, wherein the sensor component has a tubular shape and a cross section.

18. The sensor component according to claim 17, said cross section of the sensor component being a circular cross section.

19. The sensor component according to claim 18, wherein said cross section of said sensor segment is smaller than said cross section of the sensor component in said component segment.

20. The sensor component according to claim 7, said receiving component being a thin-walled cap having a receiving opening and said cap having outside diameter (AD) and an inside diameter (ID) consistent with a diameter of said receiving opening, said AD and said ID having a relationship defined by the equation AD<1.2·ID.

21. The sensor component according to claim 20, said relationship being defined by the equation AD<1.1·ID.

22. The sensor component according to claim 21, said relationship being defined by the equation AD<1.05·ID.

23. The sensor component according to claim 7, wherein said receiving component is a ring-shaped, thick-walled receiving component having an outside diameter (AD) and an inside diameter (ID) consistent with a diameter of said receiving opening, said AD and said ID having a relationship defined by the equation AD>1.3·ID.

24. The sensor component according to claim 23, said relationship being defined by the equation AD>1.4·ID.

25. The sensor component according to claim 24, said relationship being defined by the equation AD>1.5·ID.

26. The sensor component according to claim 1, wherein a size of said receiving opening is selected such that a plurality of predetermined optical requirements upon said at least one sight glass are substantially met.

27. The sensor component according to claim 26, wherein said diameter of said receiving opening is selected such that said predetermined plurality of optical requirements upon said at least one sight glass are substantially met.

28. The sensor component according to claim 27, wherein said plurality of predetermined optical requirements include a diameter of a penetrating beam.

29. An optical flow rate sensor, comprising:
at least one optical sensor including a sensor component, including
at least one component segment; and
at least one sensor segment comprising a receiving component and at least one sight glass, said at least one sensor segment including one of:
at least two sight glasses in a region of a plurality of recesses in said at least one sensor segment, said receiving component being insertable into said plurality of recesses and said at least two sight glasses being arranged such that a cross section of said at least one sensor segment is penetrable with a light, said at least two sight glasses being materially joined with said receiving component; and
one sight glass in a region of one recess of said at least one sensor segment and a reflecting surface on a side opposite said one recess, said receiving component being insertable into said one recess and said one sight glass being materially joined with said receiving component.

30. The optical flow rate sensor according to claim 29, further comprising a light source.

31. The optical flow rate sensor according to claim 30, said light source being a light emitting diode.

32. The optical flow rate sensor according to claim 31, said light emitting diode being a light emitting diode array.

33. The optical flow rate sensor according to claim 32, said light source emits a wavelength in the infrared.

34. The optical flow rate sensor according to claim 33, said wavelength being in a range between approximately 1 micrometer (μm) and 2 μm.

35. A device for receiving or transporting a fluid or gaseous medium, the device comprising:
at least one optical sensor including a sensor component, including
at least one component segment; and
at least one sensor segment comprising a receiving component and at least one sight glass, said at least one sensor segment including one of:
at least two sight glasses in a region of a plurality of recesses in said at least one sensor segment, said receiving component being insertable into said plurality of recesses and said at least two sight glasses being arranged such that a cross section of said at least one sensor segment is penetrable with a light, said at least two sight glasses being materially joined with said receiving component; and
one sight glass in a region of one recess of said at least one sensor segment and a reflecting surface on a side opposite said one recess, said receiving component being insertable into said one recess and said one sight glass being materially joined with said receiving component.

36. The device according to claim 35, said fluid or gaseous medium being one of the following:
natural gas, hydrogen, nitrogen, oxygen, exhaust from combustion engines, industrial process gasses, liquid petroleum gas, air, water, oil, a plurality of alcohols, gasoline, diesel fuel, rapeseed oil, methyl ester, fuel for aircraft turbines, urea, urea solutions and fluoric-hydrocarbons.

37. The device according to claim 36, said water being salt water.

38. The device according to claim 37, said oil is for engines, transmission and hydraulic applications.

39. The device according to claim 38, said plurality of alcohols including methanol and ethanol.

40. The device according to claim 35, further comprising a plurality of line components connected with said sensor component.

41. The device according to claim 40, said plurality of line components being connected with said at least one component segment.

42. The device according to claim 40, said line components being materially joined with said sensor component.

43. The device according to claim 42, said line components being materially joined with said sensor component through one of soldering, brazing, and welding.

44. The device according to claim 40, said plurality of line components having a cross section substantially consistent with a cross section of said sensor component in said at least one sensor segment.

45. A method for producing a sensor component for an optical flow rate sensor for at least one of fluids and gaseous media, the method comprising the steps of:
providing a sensor segment with at least one recess;
providing a receiving component with at least one receiving opening;
placing a sight glass into said at least one receiving opening of said receiving component;
placing and connecting said receiving component into said at least one recess; and
heating said sight glass and said receiving component such that said sight glass melts and is sealed into said at least one receiving opening to form a compression seal.

46. The method according to claim 45, further comprising the step of using brazing for said connecting of said receiving component with said sight glass.

47. The method for producing a sensor component for an optical flow rate sensor for at least one of fluids and gaseous media, the method comprising the steps of:
providing a sensor segment with at least one recess;
providing a receiving component with at least one receiving opening;
placing a glass solder and a sight glass in said at least one receiving opening;
heating said glass solder, said sight glass and said receiving component such that said sight glass fuses with said glass solder in said receiving opening to form a compression seal; and
placing and connecting said receiving component into said at least one recess of said sensor segment.

48. The method according to claim 47, further comprising the step of using one of brazing, laser welding and soldering for said connecting of said receiving component into said at least one recess of said sensor segment.

49. A method for producing a sensor component for an optical flow rate sensor for at least one of fluids and gaseous media, the method comprising the steps of:
providing a sensor segment with at least one recess;
providing a receiving component with one receiving opening;
providing a sight glass with metallization;
placing and soldering said sight glass with a first soldering temperature into one of said one receiving opening and a region of said receiving opening with a metal solder; and
placing and bonding said receiving component into said at least one recess of said sensor segment with a second soldering temperature, said second soldering temperature being lower than said first soldering temperature.

50. The method according to claim 49, further comprising the step of using soldering for said placing and bonding of said receiving component into said at least one recess.

51. A method for producing a sensor component for an optical flow rate sensor for at least one of fluids and gaseous media, the method comprising the steps of:
providing a sensor segment with at least one recess;
providing a receiving component with one receiving opening;
placing and soldering a sight glass with a first soldering temperature using a glass solder into one of said one receiving opening and in a region of said one receiving opening;
placing and bonding said receiving component into said at least one recess of said sensor segment with a second soldering temperature, said second soldering temperature being lower than said first soldering temperature.

52. The method according to claim 51, further comprising the step of using soldering for said placing and bonding of said receiving component into said at least one recess.
